(19) United States
(12) Patent Application Publication
(10) Pub. No.: US 2025/0128978 A1
(43) Pub. Date: Apr. 24, 2025

(54) SLOW COOLING OF REDUCED CLADDING DIAMETER OPTICAL FIBERS

(71) Applicant: CORNING INCORPORATED, CORNING, NY (US)

(72) Inventors: Scott Robertson Bickham, Corning, NY (US); Pushkar Tandon, Painted Post, NY (US)

(21) Appl. No.: 18/917,038

(22) Filed: Oct. 16, 2024

Related U.S. Application Data
(60) Provisional application No. 63/545,376, filed on Oct. 24, 2023.

(51) Int. Cl. C03B 37/027; C03B 37/03

(52) U.S. Cl. CPC C03B 37/02718; C03B 37/032; C03B 2205/72

(57) ABSTRACT

Methods, systems, and device implementing slow cooling of reduced cladding diameter optical fibers are described. An optical fiber manufacturing system may draw optical fibers based on heating and extruding, via a draw furnace, optically transmissive material. The optical fiber manufacturing system may include a cooling device positioned after the draw furnace and configured to cool the optical fibers. Cooling the optical fibers with the cooling device may include applying one or more gases with low thermal conductivity to the optical fibers. Applying the one or more gases to the optical fibers may reduce a rate at which the optical fibers are cooled. For example, the cooling device may be configured to transition the optical fibers from a relatively pliable state associated with exiting the furnace to a relatively hardened state at a relatively slow rate. The optical fibers may have a cladding diameter less than or equal to 115 μm.

This application claims the benefit of priority under 35 U.S.C § 120 of U.S. Provisional Application Ser. No. 63/545,376 filed on Oct. 24, 2023, the content of which is relied upon and incorporated herein by reference in its entirety.

### FIELD OF TECHNOLOGY

The present disclosure relates generally to manufacturing optical fibers, and more specifically to slow cooling of reduced cladding diameter optical fibers.

### BACKGROUND

Optical fibers are key components for transmitting signaling between various electronic components having a wide range of industrial, academic, and commercial applications (e.g., computers, wireless communication networks, media electronic devices such as televisions and stereos, and the like). In some cases, optical fibers may enable data transmissions over a given distance at relatively high data transfer speeds (e.g., compared to other signaling carriers). For example, one or more optical fibers may be implemented in fiber-optic cables spanning relatively large distances and may carry signaling associated with various services, such as media, internet, and phone services, among other examples.

Optical fibers may be manufactured by first heating an optically transmissive material (e.g., optical preforms) until the optically transmissive material reaches a relatively pliable (e.g., malleable, drawable) state. For example, the optically transmissive material may be heated by a furnace component to a temperature associated with a glass softening point, such that the optically transmissive material may be drawn. After heating the optically transmissive material to the relatively pliable state, the optically transmissive material may be drawn (e.g., extruded, extended) to form one or more optical fibers. In some cases, drawing the optically transmissive material may include increasing a length and decreasing a diameter (e.g., a cladding diameter) of the optically transmissive material (e.g., the optically transmissive material forms cylindrical fibrous shapes associated with one or more optical fibers).

### SUMMARY

The described techniques relate to improved methods, systems, devices, and apparatuses that support slow cooling of reduced cladding diameter optical fibers. Generally, the described techniques provide for cooling optical fibers having a relatively small cladding diameter at some rate such that the optical fibers do not transition between a relatively pliable state to a relatively hardened state in a relatively short duration. That is, the described techniques enable improved control over the cooling of optical fibers having relatively reduced diameters. For example, after heating and drawing an optically transmissive material, one or more gases may be applied (e.g., via a cooling component) to cool the optically transmissive material to form one or more optical fibers with reduced cladding diameter (e.g., less than or equal to 115 μm). The one or more gases may each be associated with a relatively low thermal conductivity (e.g., selected from a group of gases including at least argon, krypton, and xenon) and may be applied to modify a cooling rate of the optically transmissive material. In some cases, the one or more gases may be applied based on a ratio between the thermal conductivity of the one or more gases and the cladding diameter of the one or more optical fibers. In some cases, cooling the optically transmissive material at a relatively slower rate may result in a lower fictive temperature of the one or more optical fibers, thereby reducing Rayleigh scattering (e.g., light diffraction), signal attenuation (e.g., reduction of signal strength), and transmission losses throughout the one or more optical fibers.

A method is described. The method may include drawing, via a draw furnace, an optical fiber comprising a core and a cladding, the cladding having a cladding diameter less than or equal to about 115 μm. In some examples, the method may include moving the optical fiber through a cooling device such that one or more gases surround the optical fiber within the cooling device, wherein a ratio between a thermal conductivity of the one or more gases and the cladding diameter of the optical fiber is from about 4.00×10⁻⁵ cal/cm²-sec-K to about 3.00×10⁻² cal/cm²-sec-K at 1500 K.

An apparatus is described. The apparatus may include a draw furnace configured to draw an optical fiber having a cladding diameter less than or equal to 115 μm, the optical fiber comprising an optically transmissive material. In some examples, the apparatus may include a cooling device comprising one or more gases configured to cool the optical fiber for a duration, wherein a ratio between a thermal conductivity of the one or more gases and the cladding diameter of the optical fiber is from about 4.00×10⁻⁵ cal/cm²-sec-K to about 3.00×10⁻² cal/cm²-sec-K at 1500 K.

Another method is described. The method may include drawing an optically transmissive material to form an optical fiber, the optical fiber having a cladding diameter less than or equal to 115 μm. In some examples, the method may include moving the optical fiber through a cooling device that comprises one or more gases that surround the optically transmissive material as the optically transmissive material of the optical fiber cools, wherein a temperature and a duration for moving the optical fiber through the cooling device is based at least in part on the cladding diameter and a desired fictive temperature of the optical fiber.

### BRIEF DESCRIPTION OF THE DRAWINGS

FIG. 1 shows an example of a system that supports slow cooling of reduced cladding diameter optical fibers in accordance with aspects of the present disclosure.

FIG. 2 shows an example of graphed results for slow cooling of reduced cladding diameter optical fibers in accordance with aspects of the present disclosure.

FIG. 3A shows generally the cooling rate of optical fibers with different cladding diameters.

FIG. 3B shows the cooling rate of optical fibers with and without the slow cooling.

FIG. 3C shows the reduction in fictive temperature of the optical fibers of FIG. 3B.

FIGS. 4 and 5 show flowcharts illustrating methods that support slow cooling of reduced cladding diameter optical fibers in accordance with aspects of the present disclosure.

### DETAILED DESCRIPTION

During manufacturing optical fibers, an optical fiber manufacturing system may transport an optically transmissive material through one or more components of the optical fiber manufacturing system, each of which is associated with one or more stages of forming optical fibers. For example, the optical fiber manufacturing system may include at least one or more heating components (e.g., a draw furnace) operable to heat the optically transmissive material, one or more drawing components (e.g., extruder components) operable to draw (e.g., extrude) the optically transmissive material into one or more optical fibers, and one or more cooling components operable to cool the optically transmissive material (e.g., the one or more optical fibers). In some cases, one or more transport components of the optical fiber manufacturing system may move the optically transmissive material through the furnace, such that the optically transmissive material may be heated for a duration associated with a rate (e.g., a speed) at which the optically transmissive material is moved through the furnace. In some cases, the one or more cooling components may apply one or more gases associated with cooling the optically transmissive material (e.g., the extruded optically transmissive material) to solidify the one or more optical fibers.

Specifically, a process for forming the optical fibers may include heating and drawing the optically transmissive material, then subsequently cooling the optically transmissive material to form the one or more optical fibers. For example, the optically transmissive material may be heated (e.g., via the one or more heating components) to a temperature associated with causing the optically transmissive material to enter a relatively pliable state (e.g., associated with supporting manipulation of the optically transmissive material, such as extruding the optically transmissive material), then the optically transmissive material may be cooled (e.g., via the one or more cooling components) to a temperature associated with causing the optically transmissive material to exit the relatively pliable state and transition (e.g., associated with a fiber glass transition region) to a relatively hardened state. In some cases, the one or more cooling components may apply air or nitrogen gas to cool the optically transmissive material to the relatively hardened state. Air and nitrogen gas, however, may be associated with transitioning the optically transmissive material from the relatively pliable state to the relatively hardened state at a relatively high rate. In some such cases, cooling the optically transmissive material at such a relatively high rate (e.g., transitioning over a short duration) may result in a relatively high fictive temperature of the corresponding optical fibers, thereby leading to relatively high Rayleigh scattering (e.g., light diffraction), signal attenuation (e.g., signal strength), and transmission losses.

In some cases, the optically transmissive material may be drawn (e.g., via the one or more drawing components) such that a cladding diameter of the resulting optical fiber may be relatively smaller than traditional fibers. For example, in the embodiments disclosed herein, the cladding diameter of the optical fiber may be less than or equal to 115 μm (e.g., rather than 125 μm or greater as is common in traditional fibers). The mass per unit length of an optical fiber is proportional to the cross-sectional area, which is proportional to the square of the cladding diameter. Consequently, the relatively reduced cladding diameter of the optical fibers disclosed herein, and corresponding smaller mass per unit length, may further increase (e.g., exacerbate) the disadvantages of cooling the optically transmissive material at the relatively high rate discussed above. For example, cooling the reduced cladding diameter optical fiber at the relatively high rate may result in a relatively higher fictive temperature, thereby causing relatively higher Rayleigh scattering, signal attenuation, and transmission losses (e.g., compared to a traditional optical fiber with a relatively greater cladding diameter). Embodiments of the present disclosure provide a slow cooling of the optically transmissive material to prevent and/or reduce such unwanted properties in the produced optical fibers.

In accordance with examples described herein, an optical fiber manufacturing system may implement a cooling component (e.g., a slow cooling device) configured to transition the optically transmissive material from the relatively pliable state to the relatively hardened state at a relatively slow rate. For example, the cooling component may be positioned after a furnace configured to heat and draw the optically transmissive material, and the cooling component may apply one or more gases with relatively low thermal conductivity to cool the optically transmissive material at the relatively slow rate. The one or more gases may include argon, krypton, and xenon, or other gases having a relatively low thermal conductivity, or any combination thereof. In some examples, the one or more gases may be applied based on a ratio between the thermal conductivity of the one or more gases and the cladding diameter of the optically transmissive material, such that the cooling component may support the relatively slow cooling rate for reduced cladding diameter optical fibers. In some such examples, the cooling component may be configured to alter a temperature of the one or more gases applied to the optically transmissive material during cooling or modify a duration for cooling the optically transmissive material, thereby supporting controlling a cooling rate of the optically transmissive material. Thus, the cooling component may apply cooling according to the cladding diameter of the optical fibers or to facilitate the optical fibers resulting in a desired fictive temperature.

In some cases, implementing the cooling component to cool the optical fiber may support cooling at the relatively low rate, resulting in a relatively low fictive temperature of the optical fiber, and thereby leading to relatively lower Rayleigh scattering, signal attenuation, and transmission losses (compared to traditional systems). Further, configuring the cooling component to cool the optical fiber based on parameters or desired results of the optical fibers may enable the cooling component to better support reduced cladding diameter optical fibers. Thus, the cooling component may cool the reduced cladding diameter optical fibers at the relatively low rate which may result in a relatively lower fictive temperature, thereby causing relatively lower Rayleigh scattering, signal attenuation, and transmission losses.

Aspects of the disclosure are initially described in the context of a system. Aspects of the disclosure are further illustrated by and described with reference to graphed results and flowcharts that relate to slow cooling of reduced cladding diameter optical fibers.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system 100 to additionally or alternatively solve other problems than those described above. Further, aspects of the disclosure may provide technical improvements to “conventional” systems or processes as described herein.

However, the description and appended drawings only include example technical improvements resulting from implementing aspects of the disclosure, and accordingly do not represent all of the technical improvements provided within the scope of the claims.

The term “process pathway” refers to the pathway traversed by an optical fiber in an optical fiber draw process.

The relative position of one process unit relative to another process unit along the process pathway is described herein as upstream or downstream. The upstream direction of the process pathway is the direction toward the preform and the downstream direction of the process pathway is the direction toward the winding stage. Positions or processing units upstream from a reference position or processing unit are closer, along the process pathway, to the preform than the reference position or processing unit. A process unit located at a position closer to the draw furnace along the process pathway is said to be upstream of a process unit located at a position further away from the draw furnace along the process pathway. The draw furnace is upstream from all other process units and the take-up spool (or winding stage or other terminal unit) is downstream of all other process units.

The term “optical fiber” refers to a glass waveguide. The glass waveguide includes a glass core and a glass cladding. The glass cladding surrounds and is directly adjacent to the glass core. The glass cladding may include two or more concentric glass regions that differ in refractive index. The refractive index of the glass core is greater than the refractive index of the glass cladding (or the average refractive index of the glass cladding when the glass cladding includes multiple concentric regions) at a wavelength of 1550 nm.

“Fictive temperature” is used herein to refer to a concept that indicates the structural state of a glass and refers to a temperature associated with the glass transitioning from a relatively liquidous state to a relatively solidified state. Glass that is cooled quickly from a high temperature typically exhibits a higher fictive temperature than an identical glass cooled from the same temperature more slowly because of the “frozen in” higher temperature structure. When a glass is held at an elevated temperature below the glass melting point, the glass structure is allowed more time to relax toward the heat treatment temperature structure, which results in a relatively lower fictive temperature. That is, increasing a residence time of the glass in a glass transition region (e.g., a temperature range in which the glass transitions between the relatively liquidous state and the relatively solidified state) may result in the glass having a relatively lower fictive temperature. Glasses with relatively higher fictive temperatures have structures that are further removed from equilibrium than glasses with relatively lower fictive temperatures. Processing conditions that lower the fictive temperature of the glass produce optical fibers with lower attenuation.

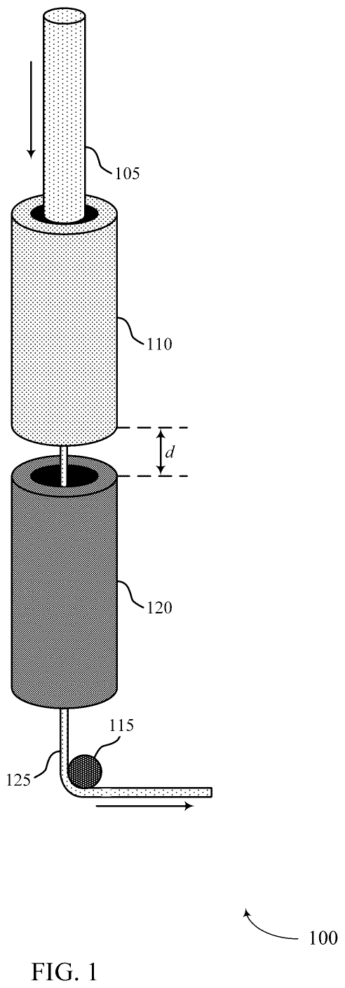

FIG. 1 shows an example of an optical fiber manufacturing system 100 that supports slow cooling of reduced cladding diameter optical fibers in accordance with aspects of the present disclosure. The system 100 may include various optical fiber manufacturing components operable to modify and draw an optically transmissive material 105 into an optical fiber 125. For example, the system 100 may include one or more heating components (e.g., a furnace 110), one or more cooling components (e.g., a cooling device 120), and one or more transport components (e.g., transporter 115) configured to modify and transport the optically transmissive material 105 within the system 100. In some cases, the one or more cooling components may be configured to cool the optically transmissive material 105 at a rate resulting in a relatively low fictive temperature, thereby causing optical fiber 125 to have relatively low Rayleigh scattering, signal attenuation, and transmission losses.

The optically transmissive material 105 may be an optical fiber preform, such that the optically transmissive material 105 may be manufactured to produce one or more optical fibers 125. Optical fiber 125 may be a transparent fibrous material configured to transport light or information over a given distance (e.g., a length of the optical fiber 125). For example, optical fiber 125 may be configured to carry signaling including a relatively high quantity of information (e.g., data) at a relatively high information transfer speed (e.g., compared to other signaling mediums). Additionally, or alternatively, optical fiber 125 may be configured to carry light or images (e.g., due to internal light reflection). In some cases, one or more optical fibers 125 may be implemented as a core portion of a fiber-optic cable, and may be surrounded with an insulating material configured to prevent light or information from exiting the fiber-optic cable. Each optical fiber 125 may include a glass core region surrounded by a glass cladding material. In some examples, the core region may be doped with germania (e.g., germanium dioxide), alkali-doped silica, chlorine-doped silica, or fluorine-doped silica, or any combination thereof. For example, the core region may include alkali-doped silica containing a relatively small quantity of fluorine.

The optically transmissive material 105 may include a silica glass material, which may further include other materials and/or dopants. In some examples, the optically transmissive material 105 may include a consolidated silica glass having one or more concentric regions of the silica glass.

The heating component may comprise a furnace 110, which may be an example of a draw furnace configured to draw the optically transmissive material 105 into one or more optical fibers 125. In some cases, the furnace 110 may include a heating element configured to heat the optically transmissive material 105 (e.g., entering into the furnace 110) and one or more drawing components (e.g., one or more extruders) configured to draw (e.g., extrude) the optically transmissive material 105. In some examples, drawing the optically transmissive material 105 may include decreasing a width and increasing a length of the optically transmissive material 105 such that the optically transmissive material 105 forms structures associated with the one or more optical fibers 125. The one or more optical fibers 125 may be drawn to have a cladding diameter (an outer diameter of the bare optical fiber 125 without any coatings) that is equal to or less than about 115 μm, or equal to or less than about 110 μm, or equal to or less than about 105 μm, or equal to or less than about 100 μm, or equal to or less than about 95 μm, or equal to or less than about 90 μm, or equal to or less than about 85 μm, among other examples. In some embodiments, the bare diameter of optical fiber 125 may be in a range from about 80 μm to about 115 μm, or about 90 μm to about 110 μm, or about 95 μm to about 105 μm. In some implementations, the one or more optical fibers 125 may include multiple cladding layers (e.g., the multiple cladding layers having a width less than half the diameter of the one or more optical fibers 125). In some implementations, the optically transmissive material 105 may be shaped (e.g., drawn) by the one or more drawing components into a circular shape such that the resulting one or more optical fibers 125 are drawn into cylindrical structures.

The heating element of the furnace 110 may be configured to heat the optically transmissive material 105 to a temperature associated with causing the optically transmissive material 105 to be relatively pliable. For example, the heating element may be thermally coupled with some portion of the furnace 110 and configured to provide sufficient heat to decrease the viscosity of the optically transmissive material 105 (e.g., for drawing the optically transmissive material 105 from a preform into an optical fiber). In some cases, the heating element may produce a temperature equal to or greater than a softening temperature of the optically transmissive material 105. For example, the heating element may heat the furnace 110 to a temperature between about 1800° C. and about 2100° C. in order to draw the optical fiber 125 from the optically transmissive material 105.

In some embodiments, the heating element may create one or more zones within the furnace 110 with relatively increased temperatures along the process pathway. It is also contemplated, in some embodiments, that the heating element of the furnace 110 comprises more than one heating element. In some cases, heating the optically transmissive material 105 (e.g., via the heating element) may enable drawing the optically transmissive material 105 (e.g., via the one or more drawing components). For example, when the optically transmissive material 105 is in the relatively pliable state, the one or more drawing components may draw the optically transmissive material 105 to a desired shape and cladding diameter. Furthermore, in some embodiments, the heating element may be configured to heat the optically transmissive material 105 such that the optically transmissive material 105 enters the cooling device 120 at a temperature between about 1050° C. and about 1600° C. Therefore, in these embodiments, the heating element is configured to heat the optically transmissive material 105 such that it enters the cooling device 120 at a temperature below the softening temperature of the glass.

As discussed above, the transporter 115 is configured to transport the optically transmissive material 105 and/or the one or more optical fibers 125 through the system 100. For example, the transporter 115 may be configured to transport the optically transmissive material 105 through the furnace 110. Furthermore, the transporter 115 may be configured to transport the one or more optical fibers 125 through the cooling device 120 and from the cooling device 120 to one or more other components of the system 100. In some examples, the transporter 115 may include one or more rotational elements configured to move the optically transmissive material 105 and/or the one or more optical fibers 125 through components (e.g., the furnace 110, the cooling device 120) of the system 100. In some examples, the transporter 115 may be located upstream of the furnace 110, downstream of the furnace 110 and upstream of the cooling device 120, and/or downstream of the cooling device 120 along the process pathway of the one or more optical fibers 125. In some embodiments, the furnace 110 encompasses the transporter 115 so that they are one unitary component. In other embodiments, the transporter 115 is a separate and distinct component from the furnace 110.

In some embodiments, the system 100 may comprise a controller (not shown) configured to modify and/or regulate operating parameters of the furnace 110, the transporter 115, and/or the cooling device 120. For example, controller may regulate the temperature of the heating element of the furnace 110 and regulate the speed of the transporter 115 such that the heating element heats the optically transmissive material 105 for a selected duration and/or to a selected temperature. The controller may also regulate the temperature of the cooling device 120. As another example, the controller may control a speed at which the transporter 115 moves the optically transmissive material 105 and/or the optical fiber 125 through the system 100. For example, the transporter 115 may be configured to move the optically transmissive material 105 and/or the optical fiber 125 through the furnace 110 or the cooling device 120, or both, such that a duration that the optically transmissive material 105 and/or the optical fiber 125 is heated (e.g., by the furnace 110) or cooled (e.g., by the cooling device 120) is dependent on a speed at which the transporter 115 moves the optically transmissive material 105 and/or the optical fiber 125 through the respective components (e.g., the furnace 110, the cooling device 120).

The cooling device 120 may be located downstream of the furnace 110 in the system 100 and may be configured to cool the one or more optical fibers 125 to a temperature associated with causing the one or more optical fibers 125 to be relatively hardened. In some examples, the cooling device 120 may be positioned immediately following the furnace 110. In some other examples, the cooling device 120 may be positioned some distance away from the furnace 110 (e.g., from the outlet of the furnace). In embodiments, the furnace 110 encompasses the cooling device 120 so that they are one unitary component. In other embodiments, the cooling device 120 is a separate and distinct component from the furnace 110. In some cases, the cooling device 120 may cool the one or more optical fibers 125 to a temperature equal to or less than a temperature associated with a relatively hardened state of the one or more optical fibers 125. For example, after the one or more optical fibers 125 exits the furnace 110, the one or more optical fibers 125 may enter the cooling device 120, where the cooling device 120 may transition the temperature of the one or more optical fibers 125 from the relatively pliable state to the relatively hardened state. In some implementations, the relatively hardened state may be a relaxed state of the one or more optical fibers 125, in which the glass of the one or more optical fibers 125 has reached an equilibrium state. In the relatively hardened state, a shape of the one or more optical fibers 125 may be established. In embodiments, the cooling device 120 cools the one or more optical fibers 125 to a temperature from about 800° C. to about 1300° C., or about 1000° C. to about 1200° C. In some implementations, the cooling device 120 may be configured to cool the one or more optical fibers 125 to a temperature based on a doping of the one or more optical fibers 125. For example, the cooling device 120 may cool germania-doped optical fibers to a temperature from about 1100° C. to about 1250° C. In another example, the cooling device 120 may cool alkali-doped optical fibers to a temperature from about 1000° C. to about 1150° C.

The residence time of each optical fiber 125 through the cooling device may be equal to or greater than about 0.05 seconds, equal to or greater than about 0.2 seconds, equal to or greater than about 0.5 seconds, equal to or greater than 1 second. Furthermore, the cooling device 120 may cool the one or more optical fibers 125 from the relatively pliable state to the relatively hardened state at a relatively slow cooling rate of less than about 5000° C./s, or less than about 2500° C./s (which is relatively slower than the rate of about 25,000° C./s for open air cooling of the one or more optical fibers 125). In embodiments, the cooling rate of the one or more optical fibers 125 is selected based on the temperature within the cooling device 120.

In some embodiments, the cooling device 120 is be configured to cool the one or more optical fibers 125 at a cooling rate such that the one or more optical fibers 125 have a fictive temperature equal to or less than about 1500° C., or equal to or less than about 1450° C., or equal to or less than about 1300° C., or equal to or less than about 1250° C., among other examples. In some cases, the cooling device 120 may be configured to cool the one or more optical fibers 125 based on the doping of the one or more optical fibers 125. For example, the cooling device 120 may be configured to cool germania-doped optical fibers at a cooling rate such that the germania-doped optical fibers have a fictive temperature between about 1475° C. and about 1500° C. In another example, the cooling device 120 may be configured to cool alkali-doped optical fibers at a cooling rate such that the alkali-doped optical fibers have a fictive temperature between about 1260° C. and about 1270° C. As discussed above, implementing the disclosed relatively slow cooling rates of the one or more optical fibers 125 may result in a relatively low fictive temperature of the produced optical fibers, which may be indicative of relatively low Rayleigh scattering, relatively low signal attenuation, and relatively low transmission losses.

The cooling device 120 may cool the one or more optical fibers 125 based on applying one or more gases to the one or more optical fibers 125. In embodiments, the cooling device 120 may include a chamber into which the one or more gases are injected, and the one or more optical fibers 125 are moved through the chamber (via transporter 115) such that the one or more gases are applied to the one or more optical fibers 125. The one or more gases may be at the same temperature as the interior of the cooling device 120 before being injected into the cooling device 120. For example, the cooling device 120 may operate at a temperature between about 900° C. and about 1300° C., such that the one or more gases may be injected into the chamber at a temperature between about 900° C. and about 1300° C. In some cases, the one or more gases may be selected from a group of gases with relatively low thermal conductivity, such as argon, krypton, xenon, or any combination thereof.

In some cases, the one or more gases may be selected based on a ratio between a thermal conductivity (k_{g}) of the one or more gases and the cladding diameter (d_{f}) of the one or more optical fibers 125 (k_{g}/d_{f}). For example, Table 1 below depicts the ratio (k_{g}/d_{f}) between the thermal conductivity for various gases at the temperature 1500 K and the cladding diameter for various cladding diameters.

TABLE 1

| | | Ratio for | Ratio for | Ratio for |
|---|---|---|---|---|
| | Thermal | 110 μm | 100 μm | 80 μm |
| | Conductivity | Diameter | Diameter | Diameter |
| | at 1500K | Optical | Optical | Optical |
| | (cal/cm- | Fiber (cal/ | Fiber (cal/cm²- | Fiber (cal/ |
| Gas | sec-K) | cm²-sec-K) | sec-K) | cm²-sec-K) |
| nitrogen | 2.20 × 10⁻⁴ | 2.00 × 10⁻² | 2.20 × 10⁻² | 2.75 × 10⁻² |
| argon | 1.27 × 10⁻⁴ | 1.16 × 10⁻² | 1.27 × 10⁻² | 1.59 × 10⁻² |
| krypton | 7.49 × 10⁻⁵ | 6.81 × 10⁻³ | 7.49 × 10⁻³ | 9.36 × 10⁻³ |
| xenon | 4.67 × 10⁻⁵ | 4.25 × 10⁻³ | 4.67 × 10⁻³ | 5.84 × 10⁻³ |

In some embodiments, the ratio k_{g}/d_{f} is in a range from about 4.00×10⁻⁵ cal/cm²-sec-K to about 3.00×10⁻² cal/cm²-sec-K, or about 4.70×10⁻⁵ cal/cm²-sec-K to about 2.70×10⁻² cal/cm²-sec-K, or about 5.00×10⁻⁵ cal/cm²-sec-K to about 2.00×10⁻² cal/cm²-sec-K, or about 7.00×10⁻⁵ cal/cm²-sec-K to about 1.70×10⁻³ cal/cm²-sec-K, or about 1.00×10⁻⁴ cal/cm²-sec-K to about 1.50×10⁻³ cal/cm²-sec-K, or about 5.00×10⁻⁴ cal/cm²-sec-K to about 1.00×10⁻³ cal/cm²-sec-K, or about 7.00×10⁻⁴ cal/cm²-sec-K to about 1.70×10⁻³ cal/cm²-sec-K, or about 1.00×10⁻³ cal/cm²-sec-K to about 5.00×10⁻³ cal/cm²-sec-K, or about 1.00×10⁻³ cal/cm²-sec-K to about 4.00×10⁻³ cal/cm²-sec-K, or about 1.00×10⁻³ cal/cm²-sec-K to about 3.00×10⁻³ cal/cm²-sec-K, or about 1.75×10⁻² cal/cm²-sec-K to about 1.00×10⁻³ cal/cm²-sec-K. In embodiments, the ratio k_{g}/d_{f} may be in a range with any of the values listed in Table 1 as endpoints. For example, the ratio k_{g}/d_{f} may be within a range from about 4.25×10⁻³ cal/cm²-sec-K to about 1.59×10⁻² cal/cm²-sec-K.

In some cases, the system 100 (e.g., the controller of the system 100) may modify operating parameters of the cooling device 120, such that the cooling device 120 may be configured to cool the one or more optical fibers 125 for a selected duration, at a selected cooling rate, to a selected temperature, to a selected fictive temperature, and/or at the desired ratio between a thermal conductivity of the respective one or more gases (e.g., applied to the one or more optical fibers 125) and the cladding diameter of the one or more optical fibers 125 (k_{g}/d_{f}).

In some cases, the system 100 (e.g., the controller of the system 100) may modify the operating parameters of the cooling device 120, such that the cooling device 120 may be configured to produce a desired measure of transmission loss in an optical fiber. For example, the cooling device 120 may be configured to cool the one or more optical fibers 125 such that a transmission loss in an optical fiber at a given distance is equal to or less than about 0.18 dB/km at 1550 nm, or equal to or less than about 0.17 dB/km at 1550 nm, or equal to or less than about 0.16 dB/km at 1550 nm, or equal to or less than about 0.15 dB/km at 1550.

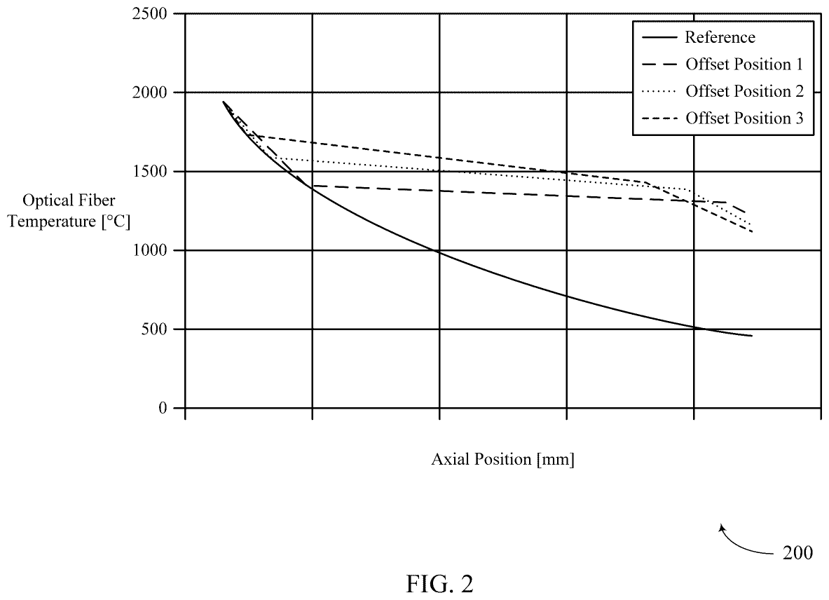

In some examples, and as described below with reference to FIGS. 1 and 2, the cooling device 120 may be offset by a distance d from the furnace 110. Specifically, the offset, d, represents a distance between an end or portion of the furnace 110 where the optical fiber 125 exits the furnace 110 and an end or portion of the cooling device 120 where the optical fiber 125 enters the cooling device 120. In some aspects, a magnitude of the distance d may be configured for a particular temperature or a range of temperatures of the optical fiber 125, enabling a low-fictive temperature for the optical fiber 125.

In accordance with examples as described herein, the system 100 may be configured to produce a relatively low fictive temperature for optical fibers 125 with reduced cladding diameters. Using the cooling device 120, the optical fibers 125 may be cooled such that the optical fibers 125 may be associated with relatively low Rayleigh scattering, low signal attenuation, and low transmission losses.

FIG. 2 shows a graph 200 for slow cooling of reduced cladding diameter optical fibers in accordance with aspects of the present disclosure. The graph 200 depicts the temperature of an optical fiber as the optical fiber moves through cooling device 120 at a constant rate (e.g., speed), as described with reference to FIG. 1, based on different distances d of the cooling device 120. The graph 200 illustrates a difference in cooling rates of optical fibers for various distances d compared to a reference cooling rate.

The y-axis of graph 200 shows the temperature (° C.) of the optical fiber, and the x-axis of graph 200 shows the axial position (mm) of the optical fiber through the cooling device based on different distances d (mm), as described with reference to FIG. 1. Therefore, graph 200 illustrates the relationship between the temperature of the optical fiber and the axial position of the cooling device 120 relative to the furnace 110. In FIG. 2, the line corresponding to Offset Position 1 illustrates an exemplary cooling device 120 that is separated from the furnace 110 by a distance d₁. The line corresponding to the Offset Position 2 illustrates an exemplary cooling device 120 that is separated from the furnace 110 by a distance d₂. And the line corresponding to the Offset Position 3 illustrates an exemplary cooling device 120 that is separated from the furnace 110 by a distance d₃, such that d₁>d₂>d₃. As shown in FIG. 2, as the distance d increases, the cooling rate of the optical fiber within the cooling device 120 decreases.

In graph 200, for each of the Offset Position plots 1, 2, and 3 shown in FIG. 2, the cooling device 120 cooled the optical fibers with argon gas at a temperature of about 1200° C., according to the embodiments disclosed herein. The graph 200 also depicts a Reference optical fiber that was cooled in ambient air and without a cooling device. Instead, the Reference optical fiber was air-cooled through the system 100 at about 25° C. Furthermore, in graph 200, for each of the plots shown in FIG. 2, the optical fibers each had an outer cladding diameter of about 85 microns.

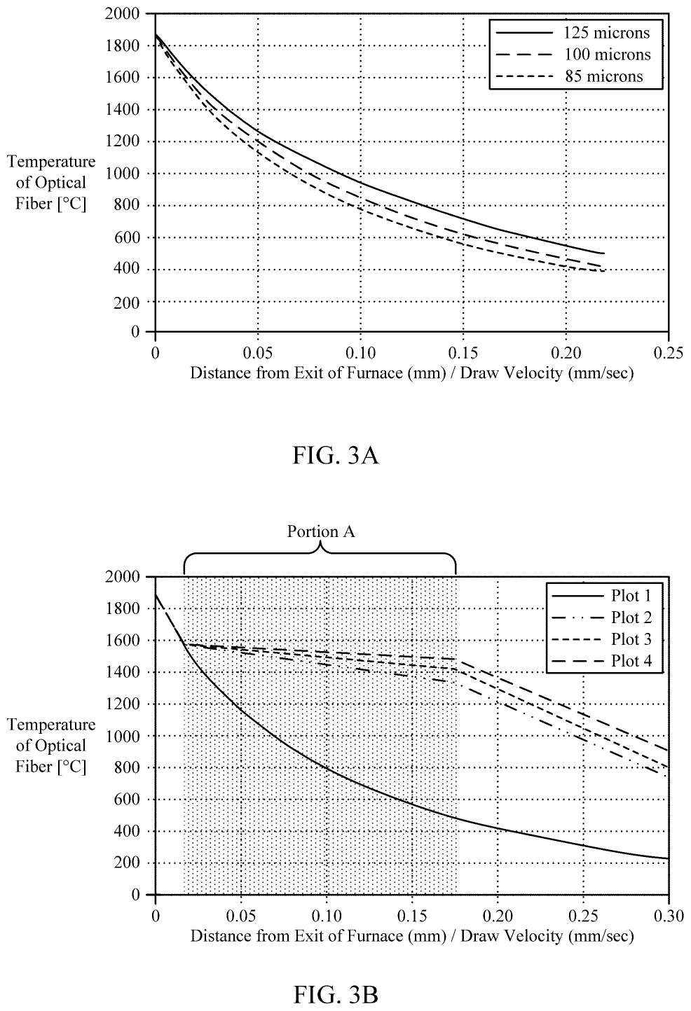

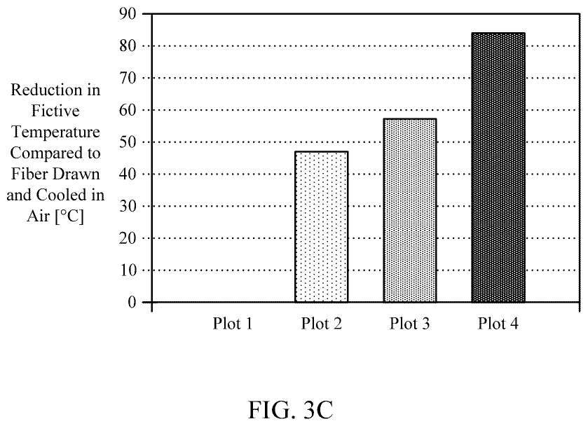

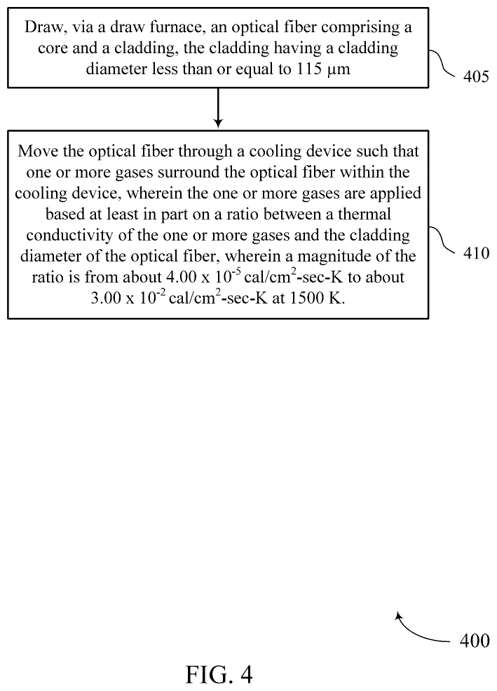

FIG. 3A shows the general relationship between the temperature of an optical fiber vs. the distance of the optical fiber from the exit of furnace 110 divided by the draw velocity of the optical fiber. It is noted that the optical fibers of FIG. 3A were not cooled with the inventive cooling device 120. Furthermore, three different optical fibers are plotted in FIG. 3A with different cladding diameters (125 microns, 100 microns, and 85 microns). As shown in FIG. 3A, an optical fiber with a smaller cladding diameter generally cools faster as the optical fiber moves a further distance from the furnace.

FIG. 3B takes the general findings of FIG. 3A and further applies those findings to the exemplary embodiments disclosed herein. In particular, FIG. 3B shows the effects of the cooling device 120 and the gases within the cooling device 120 on the cooling rate of the optical fibers. Portion A of FIG. 3B depicts the cooling of the optical fibers within the cooling device 120. Plot 1 of FIG. 3B depicts an optical fiber cooled with ambient air (without using cooling device 120), Plot 2 of FIG. 3B depicts an optical fiber cooled with nitrogen at 1200° C. within cooling device 120, Plot 3 of FIG. 3B depicts an optical fiber cooled with argon at 1200° C. within cooling device 120, and Plot 4 of FIG. 3B depicts an optical fiber cooled with krypton at 1200° C. within cooling device 120. The optical fibers of Plots 1-4 each comprised a cladding diameter of 85 microns. FIG. 3B shows that Plots 3 and 4 (which utilized argon and krypton, respectively) had much lower cooling rates than either of Plots 1 and 2 (which utilized air and nitrogen, respectively). Furthermore, FIG. 3C shows the relative fictive temperature for the optical fibers corresponding to each of Plots 1-4. The optical fibers of Plots 3 and 4 advantageously had greater reduction in fictive temperatures compared to the optical fiber drawn and cooled in ambient air.

FIGS. 3B and 3C show that implementing the cooling device 120 supports cooling the optical fiber at an advantageous slow rate. That is, cooling the optical fiber with one or more gases with low thermal conductivity may be associated with a relatively slower cooling rate than cooling the optical fiber with air or nitrogen. In some cases, the disparity between the results associated with the cooling device 120 and the comparative examples may be increased for a reduced cladding diameter optical fiber. For example, with a reduced cladding diameter fiber, the difference in the cooling rate of the optical fiber for the cooling device 120 and the comparative examples may be exacerbated. In some cases, cooling the optical fiber at the relatively slower rate may lower the fictive temperature for the resulting optical fiber, thereby reducing Rayleigh scattering, signal attenuation, and transmission loss within the optical fiber.

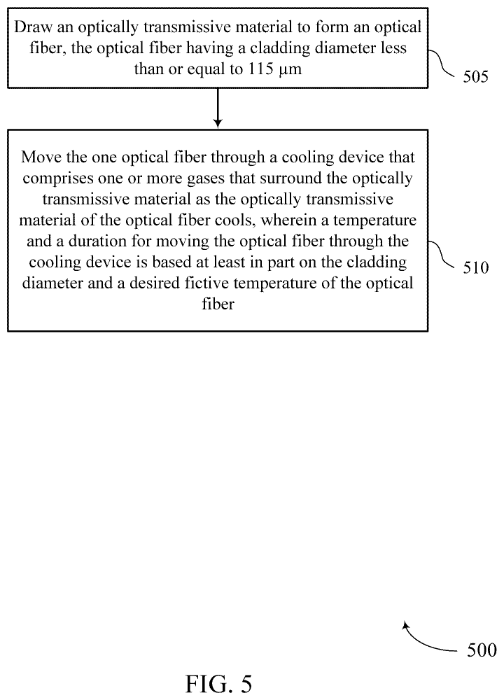

FIG. 4 shows a flowchart illustrating a method 400 that supports slow cooling of reduced cladding diameter optical fibers in accordance with aspects of the present disclosure. The operations of the method 400 may be implemented by an optical fiber manufacturing system or its components as described herein. For example, the operations of the method 400 may be performed by an optical fiber manufacturing system as described with reference to FIG. 1. In some examples, an optical fiber manufacturing system may execute a set of instructions to control the functional elements of the optical fiber manufacturing system to perform the described functions. Additionally, or alternatively, the optical fiber manufacturing system may perform aspects of the described functions using special-purpose hardware.

At 405, the method may include drawing, via a draw furnace, an optical fiber comprising a core and a cladding, the cladding having a cladding diameter less than or equal to about 115 μm. The operations of 405 may be performed in accordance with examples as disclosed herein. In some examples, aspects of the operations of 405 may be performed by a furnace 110 as described with reference to FIG. 1.

At 410, the method may include moving the optical fiber through a cooling device such that one or more gases surround the optical fiber within the cooling device, wherein a ratio between a thermal conductivity of the one or more gases and the cladding diameter of the optical fiber is from about 4.00×10⁻⁵ cal/cm²-sec-K to about 3.00×10⁻² cal/cm²-sec-K at 1500 K. The operations of 410 may be performed in accordance with examples as disclosed herein. In some examples, aspects of the operations of 410 may be performed by a cooling device 120 as described with reference to FIG. 1.

In some examples, an apparatus as described herein may perform a method or methods, such as the method 400. The apparatus may include features, circuitry, logic, means, or instructions (e.g., a non-transitory computer-readable medium storing instructions executable by a processor) for drawing, via a draw furnace, an optical fiber comprising a core and a cladding, the cladding having a cladding diameter less than or equal to 115 μm, and moving the optical fiber through a cooling device such that the one or more gases surround the optical fiber within the cooling device, wherein the one or more gases are applied based at least in part on a ratio between a thermal conductivity of the one or more gases and the cladding diameter of the optical fiber, and wherein a magnitude of the ratio is between about 4.00×10⁻⁵ cal/cm²-sec-K and about 3.00×10⁻² cal/cm²-sec-K at 1500 K.

In some examples of the method 400 and the apparatus described herein, the ratio between the thermal conductivity of the one or more gases and the cladding diameter of the optical fiber is from about 7.00×10⁻⁵ cal/cm²-sec-K to about 1.70×10⁻³ cal/cm²-sec-K at 1500 K.

In some examples of the method 400 and the apparatus described herein, the ratio between the thermal conductivity of the one or more gases and the cladding diameter of the optical fiber is from about 5.00×10⁻⁴ cal/cm²-sec-K to about 1.00×10⁻³ cal/cm²-sec-K at 1500 K.

In some examples of the method 400 and the apparatus described herein, a duration for applying the one or more gases to the optical fiber may be greater than or equal to about 0.05 seconds.

In some examples of the method 400 and the apparatus described herein, the duration may be greater than or equal to about 0.2 seconds, greater than or equal to about 0.5 seconds, or greater than or equal to about 1 second.

In some examples of the method 400 and the apparatus described herein, the one or more gases comprise argon, krypton, xenon, or a combination thereof.

In some examples of the method 400 and the apparatus described herein, the cooling device cools the optical fiber to a temperature from about 800° C. to about 1300° C.

In some examples of the method 400 and the apparatus described herein, the cooling device cools the optical fiber to a temperature from about 1000° C. to about 1200° C.

In some examples of the method 400 and the apparatus described herein, a cooling rate of the optical fiber within the cooling device is less than about 5000° C. per second.

In some examples of the method 400 and the apparatus described herein, the optical fiber, when entering the cooling device, is at a temperature between about 1050° C. and about 1600° C.

In some examples of the method 400 and the apparatus described herein, the optical fiber has a fictive temperature equal to or less than about 1500° C.

In some examples of the method 400 and the apparatus described herein, the optical fiber has a fictive temperature equal to or less than about 1300° C.

In some examples of the method 400 and the apparatus described herein, the optical fiber may have a region that may be doped with germania, that comprises alkali-doped silica, that comprises chlorine-doped silica, or comprises fluorine-doped silica, or a combination thereof.

FIG. 5 shows a flowchart illustrating a method 500 that supports slow cooling of reduced cladding diameter optical fibers in accordance with aspects of the present disclosure. The operations of the method 500 may be implemented by an optical fiber manufacturing system or its components as described herein. For example, the operations of the method 500 may be performed by an optical fiber manufacturing system as described with reference to FIG. 1. In some examples, an optical fiber manufacturing system may execute a set of instructions to control the functional elements of the optical fiber manufacturing system to perform the described functions. Additionally, or alternatively, the optical fiber manufacturing system may perform aspects of the described functions using special-purpose hardware.

At 505, the method may include drawing an optically transmissive material to form an optical fiber, the optical fiber having a cladding diameter less than or equal to 115 μm. The operations of 505 may be performed in accordance with examples as disclosed herein. In some examples, aspects of the operations of 505 may be performed by a furnace 110 as described with reference to FIG. 1.

At 510, the method may include moving the one optical fiber through a cooling device that comprises one or more gases that surround the optically transmissive material as the optically transmissive material of the optical fiber cools, wherein a temperature and a duration for moving the optical fiber through the cooling device is based at least in part on the cladding diameter and a desired fictive temperature of the optical fiber. The operations of 510 may be performed in accordance with examples as disclosed herein. In some examples, aspects of the operations of 510 may be performed by a cooling device 120 as described with reference to FIG. 1.

In some examples, an apparatus as described herein may perform a method or methods, such as the method 500. The apparatus may include features, circuitry, logic, means, or instructions (e.g., a non-transitory computer-readable medium storing instructions executable by a processor) for drawing an optically transmissive material to form an optical fiber, the optical fiber having a cladding diameter less than or equal to 115 μm and moving the one optical fiber through a cooling device that comprises one or more gases that surround the optically transmissive material as the optically transmissive material of the optical fiber cools, wherein a temperature and a duration for moving the optical fiber through the cooling device is based at least in part on the cladding diameter and a desired fictive temperature of the optical fiber.

In some examples of the method 500 and the apparatus described herein, the duration for moving the optical fiber through the cooling device is greater than or equal to about 0.05 seconds, greater than or equal to about 0.2 seconds, greater than or equal to about 0.5 seconds, or greater than or equal to about 1 second, and the desired fictive temperature is less than about 1500° C.

In some examples of the method 500 and the apparatus described herein, a ratio between a thermal conductivity of the one or more gases and the cladding diameter is from about 4.00×10⁻⁵ cal/cm²-sec-K to about 3.00×10⁻² cal/cm²-sec-K at 1500 K.

Another apparatus is described. The apparatus may include a draw furnace configured to draw an optical fiber having a cladding diameter less than or equal to 115 μm, the optical fiber comprising an optically transmissive material, and a cooling device comprising one or more gases configured to cool the optical fiber for a duration, wherein a ratio between a thermal conductivity of the one or more gases and the cladding diameter of the optical fiber is from about 4.00×10⁻⁵ cal/cm²-sec-K to about 3.00×10⁻² cal/cm²-sec-K at 1500 K.

In some examples of the apparatus, the ratio between the thermal conductivity of the one or more gases and the cladding diameter of the optical fiber is from about 7.00×10⁻⁵ cal/cm²-sec-K to about 1.70×10⁻³ cal/cm²-sec-K at 1500 K.

In some examples of the apparatus, the one or more gases comprise argon, krypton, xenon, or a combination thereof.

In some examples of the apparatus, the cooling device is configured to cool the optical fiber to a temperature from about 800° C. to about 1300° C.

In some examples of the apparatus, the optical fiber positioned within the apparatus, and wherein the optically transmissive material of the optical fiber has a fictive temperature equal to or less than about 1500° C.

In some examples of the apparatus, the optical fiber has a transmission loss at 1550 nm of less than about 0.18 dB/km.

In some examples of the apparatus, the transmission loss at 1550 nm is less than about 0.17 dB/km.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
drawing, via a draw furnace, an optical fiber comprising a core and a cladding, the cladding having a cladding diameter less than or equal to about 115 μm; and
moving the optical fiber through a cooling device such that one or more gases surround the optical fiber within the cooling device, wherein a ratio between a thermal conductivity of the one or more gases and the cladding diameter of the optical fiber is from about 4.00×10⁻⁵ cal/cm²-sec-K to about 3.00×10⁻² cal/cm²-sec-K at 1500 K.

2. The method of claim 1, wherein the ratio between the thermal conductivity of the one or more gases and the cladding diameter of the optical fiber is from about 7.00×10⁻⁵ cal/cm²-sec-K to about 1.70×10⁻³ cal/cm²-sec-K at 1500 K.

3. The method of claim 2, wherein the ratio between the thermal conductivity of the one or more gases and the cladding diameter of the optical fiber is from about 5.00×10⁻⁴ cal/cm²-sec-K to about 1.00×10⁻³ cal/cm²-sec-K at 1500 K.

4. The method of claim 1, wherein a duration for applying the one or more gases to the optical fiber is greater than or equal to about 0.05 seconds.

5. The method of claim 4, wherein the duration is greater than or equal to about 0.5 seconds.

6. The method of claim 1, wherein the one or more gases comprise argon, krypton, xenon, or a combination thereof.

7. The method of claim 1, wherein the cooling device cools the optical fiber to a temperature from about 800° C. to about 1300° C.

8. The method of claim 7, wherein the cooling device cools the optical fiber to a temperature from about 1000° C. to about 1200° C.

9. The method of claim 1, wherein a cooling rate of the optical fiber within the cooling device is less than about 5000° C. per second.

10. The method of claim 1, wherein the optical fiber, when entering the cooling device, is at a temperature between about 1050° C. and about 1600° C.

11. The method of claim 1, wherein the optical fiber has a fictive temperature equal to or less than about 1500° C.

12. The method of claim 11, wherein the optical fiber has a fictive temperature equal to or less than about 1300° C.

13. The method of claim 1, wherein the optical fiber has a region that is doped with germania, that comprises alkali-doped silica, that comprises chlorine-doped silica, or comprises fluorine-doped silica, or a combination thereof.

14. An apparatus, comprising:
a draw furnace configured to draw an optical fiber having a cladding diameter less than or equal to 115 μm, the optical fiber comprising an optically transmissive material; and
a cooling device comprising one or more gases configured to cool the optical fiber for a duration, wherein a ratio between a thermal conductivity of the one or more gases and the cladding diameter of the optical fiber is from about 4.00×10⁻⁵ cal/cm²-sec-K to about 3.00×10⁻² cal/cm²-sec-K at 1500 K.

15. The apparatus of claim 14, wherein the ratio between the thermal conductivity of the one or more gases and the cladding diameter of the optical fiber is from about 7.00×10⁻⁵ cal/cm²-sec-K to about 1.70×10⁻³ cal/cm²-sec-K at 1500 K.

16. The apparatus of claim 14, wherein the one or more gases comprise argon, krypton, xenon, or a combination thereof.

17. The apparatus of claim 14, wherein the cooling device is configured to cool the optical fiber to a temperature from about 800° C. to about 1300° C.

18. The apparatus of claim 14, further comprising the optical fiber positioned within the apparatus, and wherein the optically transmissive material of the optical fiber has a fictive temperature equal to or less than about 1500° C.

19. The apparatus of claim 18, wherein the optical fiber has a transmission loss at 1550 nm of less than about 0.18 dB/km.

20. The apparatus of claim 19, wherein the transmission loss at 1550 nm is less than about 0.17 dB/km.
